(19) United States
(12) Patent Application Publication
(10) Pub. No.: US 2025/0097071 A1
(43) Pub. Date: Mar. 20, 2025

(54) COMMUNICATION DEVICE AND COMMUNICATION SYSTEM

(71) Applicant: Kioxia Corporation, Tokyo (JP)

(72) Inventors: Hirotaka HIGASHI, Kawasaki (JP); Manabu WATANABE, Kawasaki (JP); Junji WADATSUMI, Tokyo (JP)

(73) Assignee: Kioxia Corporation, Tokyo (JP)

(21) Appl. No.: 18/829,380

(22) Filed: Sep. 10, 2024

(30) Foreign Application Priority Data
Sep. 20, 2023 (JP) 2023-153116

(51) Int. Cl. H04L 12/42; H04L 12/40

(52) U.S. Cl. CPC H04L 12/42; H04L 12/40

(57) ABSTRACT

According to one embodiment, a communication device connected in a ring shape, the communication device comprising: receiving circuitry; first circuitry configured to be capable of executing insertion and extraction of data; and transmitting circuitry configured to transmit a communication frame based on a result of the first circuitry, wherein after the receiving circuitry receives a first container including, as transmission destinations, the communication device and a first device, the transmitting circuitry is configured to transmit a second communication frame including the first container including the first device as a new transmission destination, with the communication device being excluded from the transmission destinations of the first container.

### CROSS-REFERENCE TO RELATED APPLICATION

This application is based upon and claims the benefit of priority from prior Japanese Patent Application No. 2023-153116, filed Sep. 20, 2023, the entire contents of which are incorporated herein by reference.

### FIELD

Embodiments described herein relate generally to a communication device and a communication system.

### BACKGROUND

There is known a communication system in which a host controller and a plurality of communication devices are connected in a ring shape.

### BRIEF DESCRIPTION OF THE DRAWINGS

FIG. 1 is a block diagram illustrating an entire configuration of a communication system according to a first embodiment.

FIG. 2 is a block diagram illustrating a communication device included in the communication system according to the first embodiment.

FIG. 3 is a diagram illustrating an example of a communication frame in the communication system according to the first embodiment.

FIG. 4 is a flowchart describing an example of an operation of the communication device in the communication system according to the first embodiment.

FIG. 5 is a diagram illustrating a first transmission example of a communication frame in a ring connection of the communication system according to the first embodiment.

FIG. 6 is a diagram illustrating a second transmission example of a communication frame in the ring connection of the communication system according to the first embodiment.

FIG. 7 is a flowchart describing an example of an operation of a communication device in a communication system according to a modification of the first embodiment.

FIG. 8 is a diagram illustrating a transmission example of a communication frame in a ring connection of the communication system according to the modification of the first embodiment.

FIG. 9 is a flowchart describing an example of an operation of a communication device in a communication system according to a second embodiment.

FIG. 10 is a diagram illustrating a first transmission example of a communication frame in a ring connection of the communication system according to the second embodiment.

FIG. 11 is a diagram illustrating a part of a second transmission example of a communication frame in the ring connection of the communication system according to the second embodiment.

FIG. 12 is a diagram illustrating another part of the second transmission example of the communication frame in the ring connection of the communication system according to the second embodiment.

FIG. 13 is a flowchart describing an example of an operation of a communication device in a communication system according to a third embodiment.

FIG. 14 is a diagram illustrating a transmission example of a communication frame in a ring connection of the communication system according to the third embodiment.

### DETAILED DESCRIPTION

In general, according to one embodiment, a communication device connected in a ring shape via a communication path, together with a host controller and a plurality of devices, the communication device includes a receiving circuitry configured to receive from the communication path a communication frame of a serial signal including a plurality of containers including a first container; a first circuitry configured to be capable of executing insertion and extraction of data for at least one of the plurality of containers; and a transmitting circuitry configured to transmit to the communication path the communication frame based on a processing result of the first circuitry, wherein each of the plurality of containers is capable of transferring data, with at least one of the host controller, the plurality of devices and the communication device being set as a transmission destination, and after the receiving circuitry receives a first communication frame including the first container including, as transmission destinations, the communication device and a first device of the plurality of devices, the transmitting circuitry is configured to transmit a second communication frame including the first container including the first device as a new transmission destination, with the communication device being excluded from the transmission destinations of the first container.

Hereinafter, embodiments are described with reference to the accompanying drawings. In the description below, structural elements having the same function and structure are denoted by common reference signs. In addition, in a case of distinguishing structural elements having common reference signs, suffixes are added to the common reference signs. Note that when structural elements require no particular distinction, the structural elements are denoted by common reference signs, and no suffix is added. The suffixes include, for example, lowercase alphabet added to the end of a reference sign, an index meaning an arrangement, and the like.

### 1. First Embodiment

Hereinafter, a communication system according to a first embodiment is described.

### 1.1. Configuration

A configuration of the communication system according to the first embodiment is described.

### 1.1.1. Configuration of the Communication System

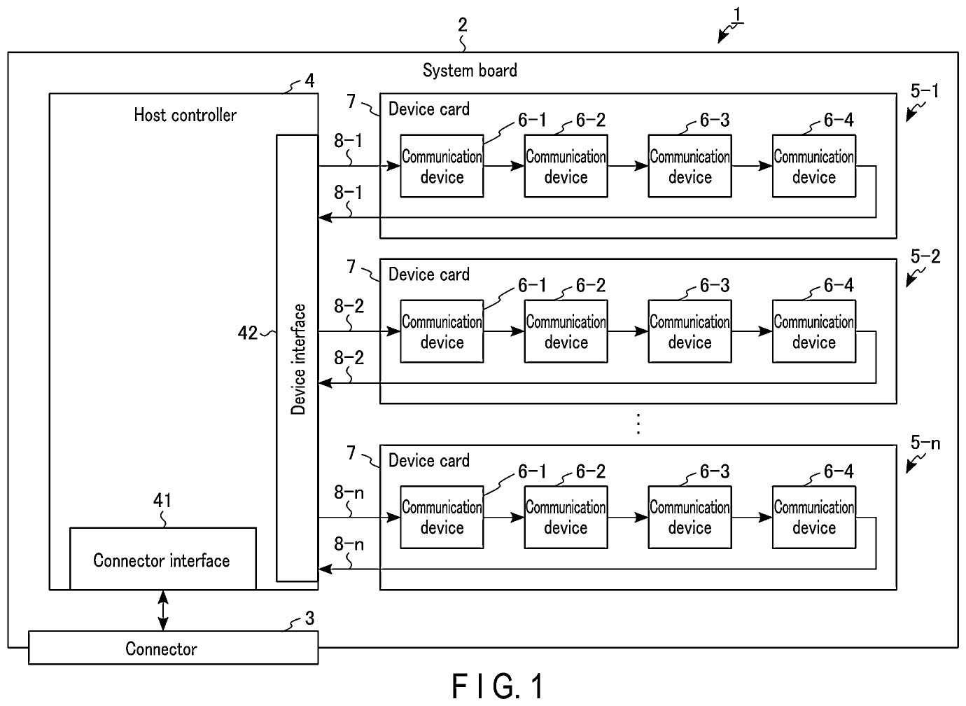

An example of the configuration of a communication system 1 is described with reference to FIG. 1. FIG. 1 is a block diagram illustrating an entire configuration of the communication system according to the first embodiment.

The communication system 1 includes a system board 2, a connector 3, a host controller 4, a plurality of device cards 5, and a plurality of communication paths 8. In the example of FIG. 1, the communication system 1 includes an n-number (n is an integer of 1 or more) of device cards 5-1 to 5-n. In addition, the communication system 1 includes an n-number of communication paths 8-1 to 8-n corresponding to the n-number of device cards 5-1 to 5-n.

The system board 2 is, for example, an accelerator board that is adaptive to an ultra-wide band and a large capacity. Note that the ultra-wide band means that, for example, a band width is 200 GB/s or more.

The connector 3 is provided on the system board 2. The connector 3 is used for a connection between the system board 2 and an external device such as a computer. The connector 3 connects, for example the system board 2 and the external device by wired connection. The connector 3 is connected to the host controller 4.

The host controller 4 controls the entirety of the communication system 1. The host controller 4 controls each of communication devices 6 mounted on the device card 5. For example, in a case where the communication device 6 is a memory device, the host controller 4 requests or instructs the communication device 6 to execute a read operation, a write operation or an erase operation of data. In the case where the communication device 6 is the memory device, the communication system 1 can also be called “memory system”. The host controller 4 includes connector interface circuitry 41 and device interface circuitry 42.

The connector interface circuitry 41 executes transmission and reception of information to and from the external device via the connector 3.

The device interface circuitry 42 executes transmission and reception of information to and from the device card 5 via the communication path 8. The device interface circuitry 42 is configured to be capable of, for example, transmitting and receiving a differential serial signal.

Each device card 5 includes a board 7 and a plurality of communication devices 6. In the example of FIG. 1, each device card 5 includes four communication devices 6-1 to 6-4. The communication devices 6-1 to 6-4 are mounted on the board 7 by soldering or by sockets. The communication devices 6-1 to 6-4 are arranged, for example, in the longitudinal direction of the board 7.

The communication device 6 is a device that operates, based on communication with the host controller 4. Hereinafter, a case is described in which the communication device 6 is a memory device in which a NAND flash memory is included. The communication device 6 is, for example, an SSD (Solid State Drive) in which a NAND flash memory is included. Note that in a case where the communication device 6 is a memory device, the device card 5 can also be called “memory card”. The communication device 6 is communicably connected to the device interface circuitry 42 via the communication path 8.

The communication paths 8-1 to 8-n correspond to the device cards 5-1 to 5-n, respectively. Each communication path 8 connects, by ring connection, the device interface circuitry 42 and the communication devices 6-1 to 6-4 included in the corresponding device card 5. To be more specific, a data output terminal of the device interface circuitry 42, input terminals and output terminals of the communication device 6-1, communication device 6-2, communication device 6-3 and communication device 6-4, and a data input terminal of the device interface circuitry 42 are connected via the communication path 8 in a ring shape. Each communication path 8 can transmit the differential serial signal.

The communication devices 6 of one device card 5 transmit and receive a communication frame of the differential serial signal via the communication path 8. The communication frame is a unit (first unit) of data that is transmitted via the communication path 8. In the ring connection, the communication frame that is output from the host controller 4 is input to the host controller 4 via the communication device 6-1, communication device 6-2, communication device 6-3 and communication device 6-4. The communication frame includes a plurality of containers, each of which can include data. The container has a smaller size than that of the communication frame, and is a unit (second unit) of data that is transmitted via the communication path 8. The structure of the container is described later. Each communication device 6 executes insertion and extraction of data into and from the containers of the communication frame in accordance with a particular condition. The insertion and extraction of data include write of data into the container (insertion of data) and read of data from the container (extraction of data).

Note that the communication system 1 may have such a configuration that the system board 2 is omitted. In addition, the connector interface circuitry 41 may be directly connected to the external device without via the connector 3. Besides, the system board 2 and the board 7 may be formed as one piece.

### 1.1.2. Configuration of the Communication Device

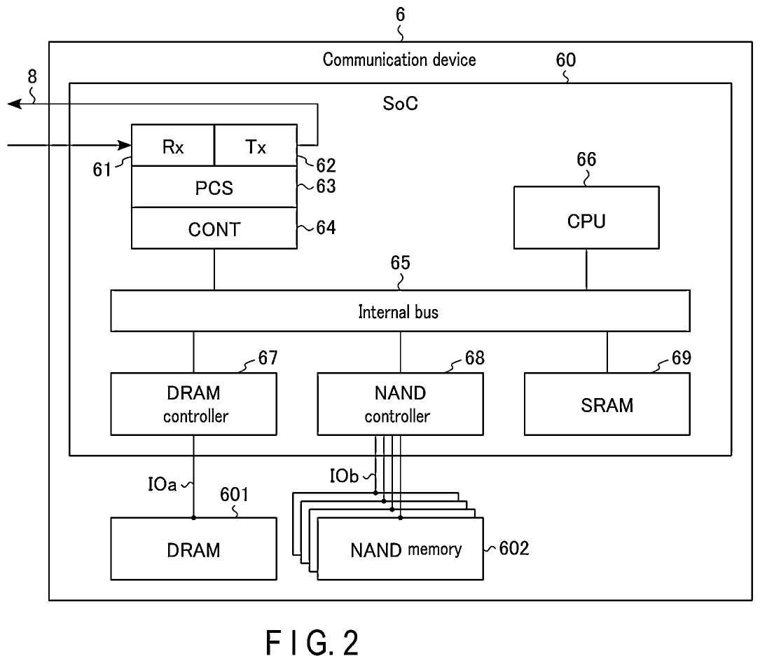

A configuration of the communication device 6 is described with reference to FIG. 2. FIG. 2 is a block diagram illustrating the communication device included in the communication system according to the first embodiment. The communication device 6 includes circuitry 60, a DRAM (Dynamic Random Access Memory) 601, and a plurality of NAND flash memories 602. Hereinafter, the NAND flash memory 602 is also referred to as “NAND memory 602”.

The circuitry 60 is, for example, an integrated circuit such as an SoC (System-on-a-Chip). The circuitry 60 is a device that operates in response to a request from the host controller 4. The circuitry 60 controls the DRAM 601 and the NAND memories 602. The circuitry 60, for example, instructs the NAND memory 602 to execute a read operation, a write operation or an erase operation. The circuitry 60 includes a receiving unit (hereinafter, also referred to as “Rx”) 61, a transmitting unit (hereinafter, also referred to as “Tx”) 62, a protocol conversion unit (hereinafter, also referred to as “PCS”) 63, communication control circuitry (hereinafter, also referred to as “CONT”) 64, an internal bus 65, a CPU (Central Processing Unit) 66, a DRAM controller 67, a NAND controller 68, and an SRAM (Static Random Access Memory) 69. The circuitry 60 is constituted as a circuitry device including these structural components.

The structure of the communication device 6, which includes the receiving unit 61, transmitting unit 62, protocol conversion unit 63 and communication control circuitry 64, functions as interface circuitry that controls transmission and reception of data between the host controller 4 and the communication device 6. The communication control circuitry 64, CPU 66, DRAM controller 67, NAND controller 68 and SRAM 69 are interconnected by the internal bus 65.

The receiving unit 61 is receiving circuitry. The receiving unit 61 corresponds to a physical layer. The receiving unit 61 is connected to the communication path 8 and the protocol conversion unit 63. The receiving unit 61 receives the communication frame via the communication path 8 from the host controller 4 or from the communication device 6 at the front stage. The receiving unit 61 applies physical processing, such as waveform equalization, to the received communication frame, and supplies the resultant communication frame to the protocol conversion unit 63.

The transmitting unit 62 is transmitting circuitry. The transmitting unit 62 corresponds to the physical layer. The transmitting unit 62 is connected to the communication path 8 and the protocol conversion unit 63. The transmitting unit 62 applies physical processing, such as waveform equalization, to the communication frame supplied from the protocol conversion unit 63. The transmitting unit 62 transmits the processed communication frame to the communication path 8 that is directed to the communication device 6 at the rear stage or the host controller 4.

The protocol conversion unit 63 executes protocol conversion of the communication frame. The protocol conversion unit 63 corresponds to a link layer. The protocol conversion unit 63 is connected to the communication control circuitry 64. The protocol conversion unit 63, for example, executes protocol conversion for the processed communication frame received from the receiving unit 61, in accordance with a protocol of an upper-level layer. The upper-level layer is a layer of a higher level than a link layer, in a case where a communication layer structure in the communication between the host controller 4 and the communication device 6 is generally classified. For example, the internal bus 65, and the CPU 66, DRAM controller 67, NAND controller 68, SRAM 69, DRAM 601 and NAND memories 602, which are connected to the communication control circuitry 64 via the internal bus 65, correspond to the upper-level layers. To be more specific, the protocol conversion unit 63 executes protocol conversion for the processed communication frame received from the receiving unit 61, in accordance with a bus protocol of the internal bus 65. The protocol conversion unit 63 transmits the communication frame, which is protocol-converted in accordance with the upper-level layer, to the communication control circuitry 64.

In addition, the protocol conversion unit 63 executes protocol conversion for the communication frame received from the communication control circuitry 64, in accordance with a protocol of a lower-level layer. The lower-level layer is a layer of a lower level than the physical layer, in the case where the communication layer structure is generally classified. To be more specific, the protocol conversion unit 63 executes protocol conversion for the communication frame received from the communication control circuitry 64, in accordance with a protocol corresponding to the communication path 8. The protocol conversion unit 63 transmits the communication frame, which is protocol-converted in accordance with the lower-level layer, to the transmitting unit 62.

The communication control circuitry 64 is configured to be capable of executing, in each communication device 6, insertion and extraction of data into and from the container corresponding to the present communication device 6. The communication control circuitry 64 corresponds to the link layer. The communication control circuitry 64 extracts, for example, data (information) from the container corresponding to this communication device 6 in the communication frame received from the protocol conversion unit 63. In addition, the communication control circuitry 64 can insert data into the container. The data inserted into the container is a response signal (response packet, response data) that is transmitted and received between the communication control circuitry 64 and the upper-level layer in accordance with a read operation, a write operation or an erase operation that is executed in the upper-level layer. The response signal includes a transmitting unit (packet) of data, or an acknowledgment response (ACK) relating to these operations.

The CPU 66 is a processor. The CPU 66 controls the operation of the entirety of the communication device 6, based on a request from the host controller 4. The CPU 66 controls, via the internal bus 65, the DRAM controller 67, NAND controller 68, and SRAM 69. The CPU 66, for example, instructs the NAND controller 68 to execute a read operation, a write operation or an erase operation for the NAND memory 602.

The DRAM controller 67 controls the DRAM 601, based on a request from the CPU 66. The DRAM controller 67 transmits and receives data to and from the DRAM 601 via a signal line IOa.

The DRAM 601 is a volatile memory. Note that in the communication device 6, instead of the DRAM 601, another volatile memory or a nonvolatile memory may be included. The DRAM 601 temporarily stores data that the circuitry 60 reads out from the NAND memory 602, or write data that the circuitry 60 receives from the host controller 4. Note that the DRAM 601 may be included in the inside of the circuitry 60.

The NAND controller 68 controls the NAND memories 602. One NAND controller 68 can control a plurality of NAND memories 602. The NAND controller 68 transmits and receives data to and from the NAND memory 602 via a signal line IOb. For example, the NAND controller 68 transmits data (command, address, write data, and the like) corresponding to a read operation, write operation or erase operation to the NAND memory 602. In addition, at a time of a read operation, the NAND controller 68 receives data that is read out from the NAND memory 602.

The NAND memory 602 is a nonvolatile storage medium. Note that in the communication device 6, instead of the NAND memory 602, a nonvolatile storage medium other than the NAND flash memory may be included. The NAND memory 602 nonvolatilely stores the data received from the NAND controller 68. In addition, the NAND memory 602 reads out nonvolatilely stored data and transmits the read-out data to the NAND controller 68.

The SRAM 69 is a volatile memory. Note that in the communication device 6, instead of the SRAM 69, another memory having a higher access speed than the DRAM 601 may be included. The SRAM 69 can be used as a working area of the CPU 66.

### 1.1.3. Structure of the Communication Frame

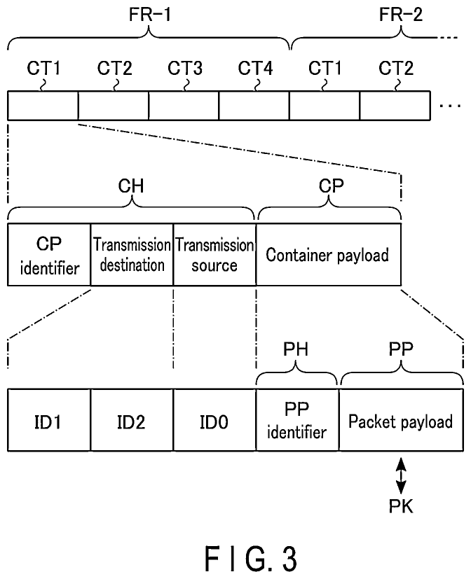

An example of the structure of the communication frame is described with reference to FIG. 3. FIG. 3 is a diagram illustrating an example of the communication frame in the communication system according to the first embodiment.

A plurality of communication frames FR are successively transmitted from the host controller 4. In the example of FIG. 3, a communication frame FR-1 and a part of a communication frame FR-2, among the communication frames FR, are illustrated. Each communication frame FR includes, for example, a plurality of containers CT each having an equal fixed length. In the example of FIG. 3, each communication frame FR includes four containers (CT1 to CT4). Note that the number of containers CT included in each communication frame FR is not limited to four, and may be a number corresponding to, for example, a band required for the communication system 1, a band of each communication device 6, the number of communication devices 6, and the like.

In each container CT, for example, data that is inserted and extracted in and from the host controller 4 or one or more communication devices 6, among the communication devices 6, can be stored. In other words, in each container CT, for example, data corresponding to the host controller 4, or data corresponding to one or more communication devices 6, among the communication devices 6, can be stored. FIG. 3 illustrates an example in which data corresponding to the communication devices 6-1 and 6-2 is stored in the container CT1. Note that each container CT may be in an empty (Null) state in which no data is stored.

The container CT includes a container header CH and a container payload CP.

The container header CH includes a CP identifier, transmission destination information, and transmission source information. Note that the container header CH may not include the transmission source information. The CP identifier is an identifier that identifies a start of the container payload CP and an end of the container payload CP, in a case where a plurality of containers CT are transferred together. The transmission destination information includes identification information ID for identifying a destination of transmission. In the description below, pieces of identification information ID of the host controller 4, communication device 6-1, communication device 6-2, communication device 6-3 and communication device 6-4 are referred to as identification information ID0, ID1, ID2, ID3, and ID4, respectively. The transmission destination information can include, for example, the identification information ID0 of the host controller 4, or the identification information ID of one or more communication devices 6 among the communication devices 6-1 to 6-4. For example, in a case of requesting a data write operation to a plurality of communication devices 6, the transmission destination information of one container CT includes a plurality of pieces of identification information ID. In addition, for example, in a case of requesting a write operation, a read operation or an erase operation to one communication device 6, the transmission destination information of one container CT includes a single piece of identification information ID. The example of FIG. 3 illustrates a case where two pieces of identification information ID1 and ID2 are included as the transmission destination information. The transmission source information includes identification information ID for identifying a source of transmission. The example of FIG. 3 illustrates a case where one identification information ID0 is included as the transmission source information.

The container payload CP includes data that is transmitted and received between the lower-level layer and the upper-level layer. The container payload CP includes a packet header PH and a packet payload PP. The container payload CP can include, for example, a plurality of packet payloads PP.

The packet header PH includes a PP identifier. The PP identifier is an identifier that identifies, in a case where a plurality of packet payloads PP are transferred together, a start of the packet payloads PP and an end of the packet payloads PP.

The packet payload PP includes, for example, data or a response signal relating to an operation that is executed in the upper-level layer. In other words, the packet payload PP includes data of a packet PK that is transmitted and received between the communication control circuitry 64 and the upper-level layer, or data of a response packet. To be more specific, in a case where data relating to an operation that is executed in the upper-level layer is included in the packet payload PP, the packet payload PP includes, for example, information (address) representing the transmission destination, attribute information (command) of a read operation, write operation or erase operation executed in the upper layer, data (write data or read data), and information of a packet length. In a case where a write operation is executed in the NAND memory 602, the packet payload PP that is transmitted from the lower-level layer to the upper-level layer includes, for example, a write command, an address, and write data. In addition, in a case where a read operation was executed in the NAND memory 602, the packet payload PP that is transmitted from the upper-level layer to the lower-level layer includes, for example, read data. Note that in a case where the container header CH includes a plurality of pieces of transmission destination information, the packet payload PP can include addresses of a plurality of transmission destinations corresponding to the plurality of pieces of transmission destination information. Thereby, for example, the write data included in the packet payload PP can be written into the NAND memories 602 of the plural communication devices 6, based on the addresses of the plural transmission destinations.

### 1.2. Operation

Next, an operation example of the communication system 1 according to the first embodiment is described. Hereinafter, at first, a description is given of an example of extraction of data of the container CT by each communication device 6 in the first embodiment. In addition, a first transmission example and a second transmission example in the first embodiment are described. These examples illustrate a case in which the container CT including data that requests a write operation is transmitted.

In addition, in the description below, the Figure illustrating each transmission example illustrates the host controller 4, and one device card 5 connected to the host controller 4. In the Figure, the depiction of the DRAM 601, NAND memories 602, CPU 66, DRAM controller 67, NAND controller 68 and SRAM 69, among the structural components of each communication device 6, is omitted.

### 1.2.1. Operation of the Communication Device

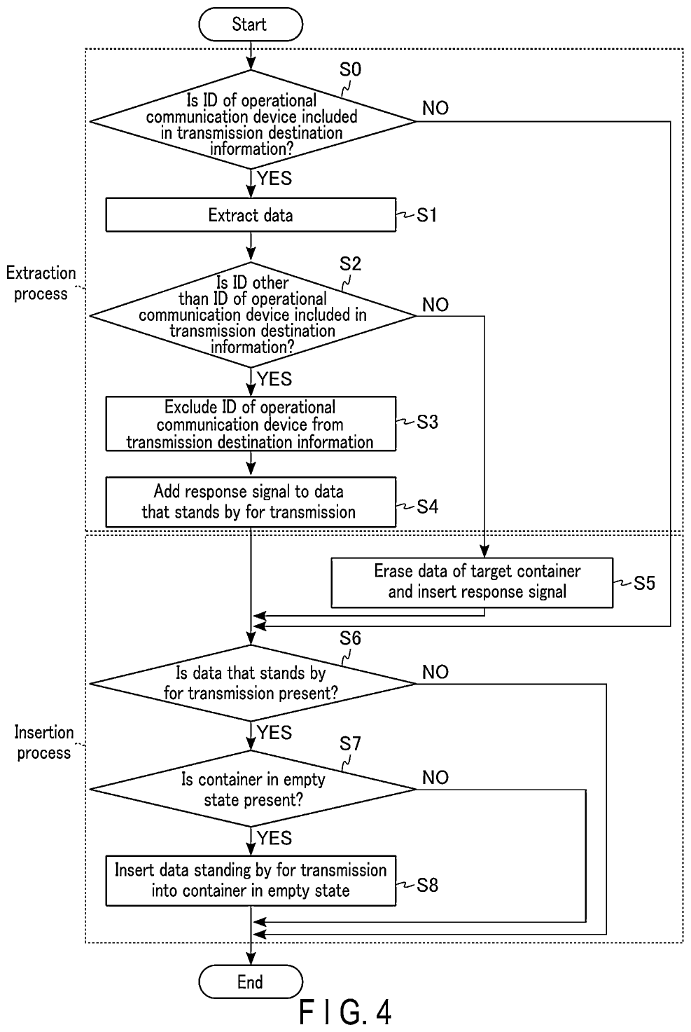

An example of the operation of the communication device 6 is described with reference to FIG. 4. FIG. 4 is a flowchart describing an example of the operation of the communication device in the communication system according to the first embodiment. Specifically, FIG. 4 illustrates an example of a process for the communication frame FR by the communication device 6.

In the communication device 6 that received the communication frame FR, the communication control circuitry 64 determines whether the identification information ID of the present communication device 6 is included as the transmission destination information of the container header CH of each container CT of the communication frame FR (S0). If the identification information ID of the present communication device 6 is not included as the transmission destination information (S0; NO), the process proceeds to S6.

If the identification information ID of the present communication device 6 is included as the transmission destination information (S0; YES), the communication control circuitry 64 extracts data from the container payload CP (packet payload PP) of the present container CT (S1). In addition, the communication control circuitry 64 transmits the extracted data to the upper-level layer as a packet PK. In addition, the CPU 66 causes an operation, such as a write operation, a read operation or an erase operation, to be executed, based on the extracted data (packet PK). Then, the process proceeds to S2.

The communication control circuitry 64 determines whether the transmission destination information of the container CT (target container CT), in which the data extraction was executed, includes identification information ID other than the identification information ID of the communication device 6 (operational communication device 6) in which the data extraction was executed (S2).

If the transmission destination information of the target container CT includes identification information ID other than the identification information ID of the operational communication device 6 (S2; YES), the communication control circuitry 64 converts the transmission destination information of the target container CT to transmission destination information in which the identification information ID of the operational communication device 6 is excluded from the transmission destination information of the target container CT at the time of reception by the receiving unit 61 (S3). Thereby, the data (container payload CP) included in the target container CT is set to be the data corresponding to the identification information ID included in the transmission destination information after the conversion. Note that in the process of S3, not only the identification information ID, but also the address of the transmission destination in the operational communication device 6 may be deleted. In addition, since the address of the transmission destination in the operational communication device 6 is not used in the communication device 6 at the rear stage, the address may not be deleted in the process of S3 although the transmission destination information is updated. Then, the process proceeds to S4.

The communication control circuitry 64, for example, adds a response signal relating to the operation based on the data extracted in S1, to the data that stands by (or waits) for transmission (S4). The data standing by for transmission is stored, for example, in the DRAM 601 or NAND memory 602 of the operational communication device 6. Note that in a case where there is no data standing by for transmission in the operational communication device 6 at a time when the data extraction was executed as described above, the communication control circuitry 64 sets the response signal as the data standing by for transmission. Then, the process proceeds to S6.

If the transmission destination information of the target container CT does not include identification information ID other than the identification information ID of the operational communication device 6 (S2; NO), the communication control circuitry 64 erases (discards) the data of the target container CT and inserts a response signal relating to the operation based on the data extracted in S1 (S5). To be more specific, the communication control circuitry 64, for example, discards the data (container payload CP) of the target container CT, and inserts the response signal into the container payload CP of the target container CT. In addition, the communication control circuitry 64 converts the transmission destination information of the target container CT to the identification information ID0 of the host controller 4. Then, the process proceeds to S6.

The communication control circuitry 64 determines whether data standing by for transmission is present in the operational communication device 6 (S6). If the data standing by for transmission is present (S6; YES), the process proceeds to S7. If data standing by for transmission is absent (S6; NO), the process for the communication frame FR is terminated. Note that when the identification information ID of the operational communication device 6 is not included (S0; NO) and data standing by for transmission is absent (S6; NO), the process relating to the insertion and extraction of data for the communication frame FR by the operational communication device 6 is not executed. In addition, when the transmission destination information of the target container CT includes identification information ID other than the identification information ID of the operational communication device 6 (S2; YES), the process (determination) of S6 may not be executed since the process of S4 is executed.

The communication control circuitry 64 determines whether a container CT in an empty state is present (S7). If the container CT in the empty state is present (S7; YES), the process proceeds to S8. If the container CT in the empty state is absent (S7; NO), the process for the communication frame FR is terminated. Note that also in a case where the identification information ID of the operational communication device 6 is not included (S0; NO) and the container CT in the empty state is absent (S7; NO) even when the data standing by for transmission is present (S6; YES), the process relating to the insertion and extraction of data for the communication frame FR by the operational communication device 6 is not executed.

The communication control circuitry 64 inserts the data standing by for transmission into the container CT in the empty state (S8). To be more specific, the communication control circuitry 64 converts the transmission destination information of the container header CH of the container CT in the empty state to the identification information ID0 of the host controller 4. In addition, the communication control circuitry 64 inserts the data standing by for transmission into the container payload CP of the container CT in the empty state. Then, the process for the communication frame FR is terminated.

In the above-described operation of the communication device 6, the processes of S0 to S4 can be called “extraction process”. In addition, the processes of S5 to S8 can be called “insertion process”.

The communication frame FR, which is updated as described above, is transmitted from the transmitting unit 62. Then, the process is terminated.

### 1.2.2. First Transmission Example of the First Embodiment

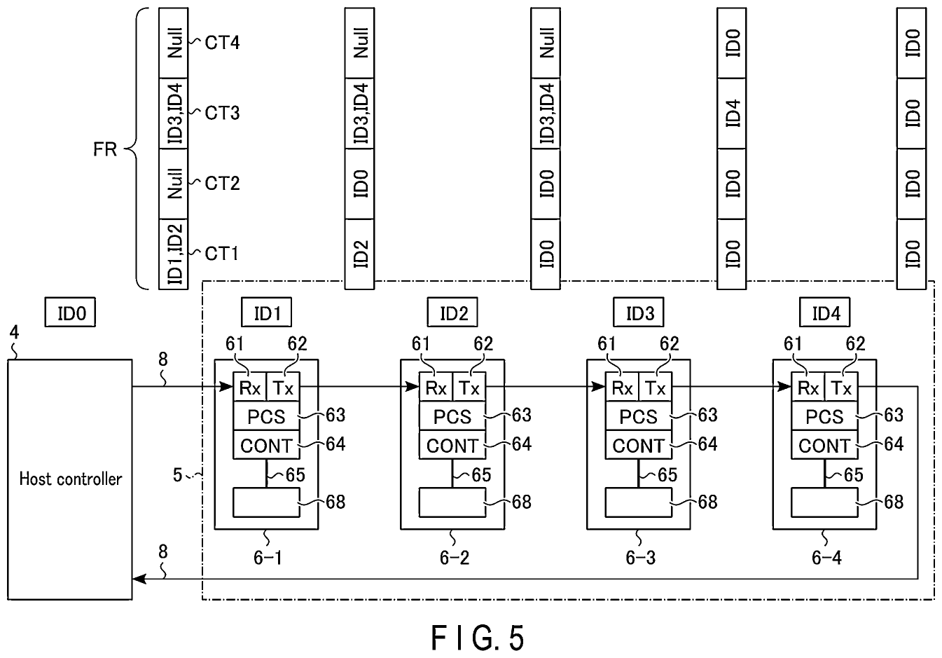

Referring to FIG. 5, a description is given of a first transmission example of the communication frame FR in the ring connection according to the first embodiment. FIG. 5 is a diagram illustrating the first transmission example of the communication frame in the ring connection of the communication system according to the first embodiment. FIG. 5 illustrates containers CT1 to CT4 included in the communication frame FR at a time when the processes in the communication devices 6 were successively executed.

The host controller 4, for example, transmits to the communication device 6-1 a communication frame FR in which data corresponding to identification information ID1 (communication device 6-1) and identification information ID2 (communication device 6-2) is stored in the container CT1, data corresponding to identification information ID3 (communication device 6-3) and identification information ID4 (communication device 6-4) is stored in the container CT3, and the containers CT2 and CT4 are in the empty state (Null). The container CT1 stores, for example, a command for requesting that the same write data be written in the communication devices 6-1 and 6-2, addresses, and the write data. The container CT3 stores, for example, a command for requesting that the same write data be written in the communication devices 6-3 and 6-4, addresses, and the write data.

In the communication device 6-1, extraction of data of the container CT1 is executed. In addition, based on the extracted data, a write operation for the NAND memory 602 is executed by the CPU 66. In addition, the communication control circuitry 64 converts the transmission destination information of the container header CH of the container CT1 from the identification information ID1 and ID2 to the identification information ID2. Thereby, the data included in the container CT1, which is transmitted from the transmitting unit 62 of the communication device 6-1, is set to be the data corresponding to the identification information ID2 (communication device 6-2). In addition, the communication control circuitry 64 inserts a response signal into the container CT2 in the empty state, with the host controller 4 being set as the transmission destination. In this manner, the communication frame FR is updated. Then, the communication device 6-1 transmits the updated communication frame FR to the communication device 6-2.

In the communication device 6-2, by a similar process as in the communication device 6-1, the data extraction of the container CT1, and the write operation are executed. The communication control circuitry 64 converts the transmission destination information of the container header CH of the container CT1 from the identification information ID2 to the identification information ID0. In addition, the communication control circuitry 64 inserts a response signal into the container CT1, with the host controller 4 being set as the transmission destination. In this manner, the communication frame FR is updated. Then, the communication device 6-2 transmits the updated communication frame FR to the communication device 6-3.

The processes in the communication devices 6-3 and 6-4 are substantially the same as the processes in the communication devices 6-1 and 6-2, except that the container CT and the identification information ID are different. The communication device 6-4 transmits the communication frame FR, which is updated as described above, to the host controller 4.

By the above, the process of the first transmission example of the first embodiment is terminated.

In addition, by the above, identical write data is written in the communication devices 6-1 and 6-2, and identical write data is written in the communication devices 6-3 and 6-4.

Although not illustrated in FIG. 5, in the container CT in which the response signal is inserted by the communication control circuitry 64 of each communication device 6, the identification information ID corresponding to the present communication device 6, for example, can be inserted as the transmission source information by the present communication control circuitry 64.

### 1.2.3. Second Transmission Example of the First Embodiment

In the above-described first transmission example, the case was illustrated in which two pieces of identification information ID are included as the transmission destination information of each of the containers CT1 and CT3, but the embodiment is not limited to this. Three or more pieces of identification information ID can be included in the transmission destination information of one container CT.

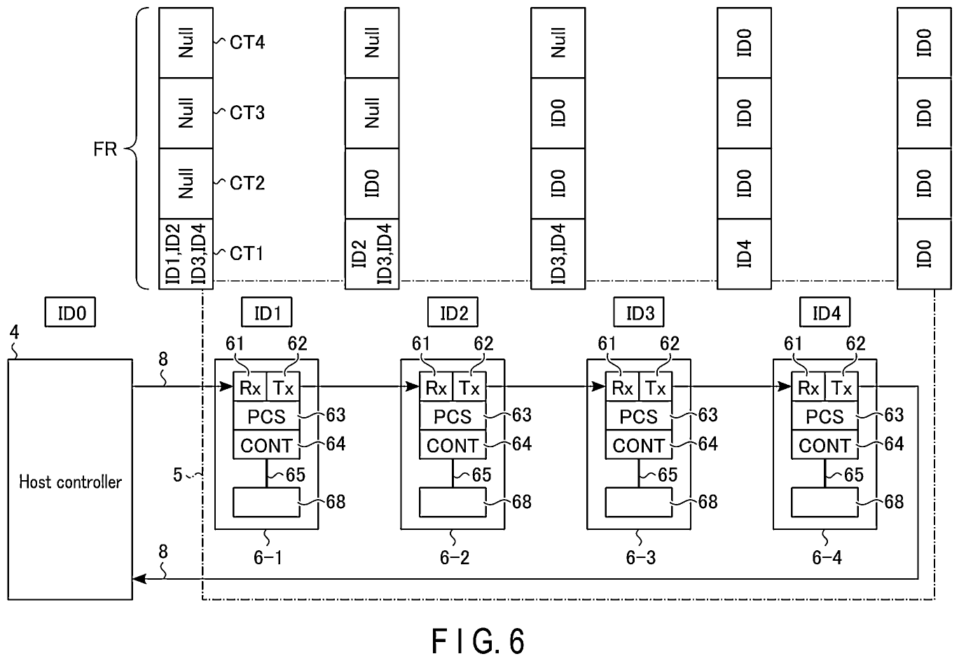

Referring to FIG. 6, a description is given of a second transmission example of the communication frame FR in the ring connection according to the first embodiment. FIG. 6 is a diagram illustrating the second transmission example of the communication frame in the ring connection of the communication system according to the first embodiment. FIG. 6 illustrates containers CT1 to CT4 included in the communication frame FR at a time when the processes in the communication devices 6 were successively executed.

The host controller 4, for example, transmits to the communication device 6-1 a communication frame FR in which data corresponding to identification information ID1 (communication device 6-1), identification information ID2 (communication device 6-2), identification information ID3 (communication device 6-3) and identification information ID4 (communication device 6-4) is stored in the container CT1, and the containers CT2, CT3 and CT4 are in the empty state (Null). The container CT1 stores, for example, a command for requesting that the same write data be written in the communication devices 6-1, 6-2, 6-3 and 6-4, addresses, and write data.

The process by the communication device 6-1 is similar to the process by the communication device 6-1 in the first transmission example, except for the conversion of the transmission destination information of the container CT1. The transmission destination information of the container header CH of the container CT1 is converted from the identification information ID1, ID2, ID3 and ID4 to the identification information ID2, ID3 and ID4 by the communication control circuitry 64. Thereby, the data included in the container CT1, which is transmitted from the transmitting unit 62 of the communication device 6-1, is set to be the data corresponding to the identification information ID2, ID3 and ID4 (communication devices 6-2, 6-3 and 6-4).

The process by the communication device 6-2 is similar to the process by the communication device 6-2 in the first transmission example, except for the conversion of the transmission destination information of the container CT1. The transmission destination information of the container header CH of the container CT1 is converted from the identification information ID2, ID3 and ID4 to the identification information ID3 and ID4 by the communication control circuitry 64. Thereby, the data included in the container CT1, which is transmitted from the transmitting unit 62 of the communication device 6-2, is set to be the data corresponding to the identification information ID3 and ID4 (communication devices 6-3 and 6-4). Note that the response signal by the communication device 6-2 is inserted into the container CT3 in the empty state.

The process by the communication device 6-3 is similar to the process by the communication device 6-3 in the first transmission example, except for the extraction of data from the container CT1. The transmission destination information of the container header CH of the container CT1 is converted from the identification information ID3 and ID4 to the identification information ID4 by the communication control circuitry 64. Thereby, the data included in the container CT1, which is transmitted from the transmitting unit 62 of the communication device 6-3, is set to be the data corresponding to the identification information ID4 (communication device 6-4). Note that the response signal by the communication device 6-3 is inserted into the container CT4 in the empty state.

The process by the communication device 6-4 is similar to the process by the communication device 6-4 in the first transmission example, except for the extraction of data from the container CT1. The transmission destination information of the container header CH of the container CT1 is converted from the identification information ID4 to the identification information ID0 by the communication control circuitry 64. Note that the response signal by the communication device 6-4 is inserted into the container CT1 from which data was extracted.

By the above, the process in the second transmission example of the first embodiment is terminated.

In addition, by the above, identical write data is written in the communication devices 6-1, 6-2, 6-3 and 6-4.

### 1.3. Advantageous Effects

According to the communication system 1 of the first embodiment, the processing capability of communication can be improved. Hereinafter, the advantageous effects of the communication system 1 according to the first embodiment are described.

According to the communication system 1 of the first embodiment, a plurality of communication devices 6 can be included as the transmission destination information of each container CT. Thereby, for example, in a case where data to be transmitted from the host controller 4 to the plurality of communication devices 6 is identical, a decrease in efficiency of use of the communication frame FR can be suppressed. Accordingly, the processing capability of communication can be improved.

A supplementary description is given. In a communication system in which only one communication device is included as the transmission destination information of each container, in order to transmit identical data from the host controller to a plurality of communication devices, the same number of containers as the number of communication devices are necessary. Thereby, in a case of writing identical write data into a plurality of communication devices by applying, for example, a RAID (Redundant Arrays of Independent Disks) 1 method, a plurality of containers, which have different information relating to the transmission destination, but in which substantially identical data (commands and write data) is stored, are transmitted. Thus, the efficiency of use of the communication frame may deteriorate.

According to the first embodiment, each container CT can include a plurality of communication devices 6 as the transmission destination information. Thereby, for example, in the case of writing certain write data by applying the RAID 1 method, the host controller 4 can set the transmission destination information of the container CT, in which this write data is stored, to a plurality of communication devices 6. Thus, in the case of writing identical write data into the plurality of communication devices 6, it is possible to suppress transmission of a plurality of containers CT each including substantially identical data. Therefore, the decrease in efficiency of use of the communication frame FR can be suppressed.

### 2. Modification of the First Embodiment

Next, a modification of the first embodiment is described.

In the above-described first embodiment, the case was illustrated in which one identification information ID is included as the transmission source information of the container header CH of each container CT. However, the embodiment is not limited to this. In the container header CH of each container CT, a plurality of pieces of identification information ID may be included as the transmission source information.

A configuration of a communication system 1 according to the modification of the first embodiment can be similar to the configuration of the communication system 1 according to the first embodiment. Hereinafter, a communication frame FR and a transmission example in the modification of the first embodiment are described.

### 2.1. Communication Frame

In the communication frame FR according to the modification of the first embodiment, the transmission source information of the container header CH can include, for example, the identification information ID0 of the host controller 4, or the identification information ID of one or more communication devices 6 among a plurality of communication devices 6. The structures of the transmission destination information, CP identifier and container payload CP in the container header CH according to the modification of the first embodiment are similar to those structures according to the first embodiment.

### 2.2. Operation

Hereinafter, an operation example of the communication system 1 is described. At first, an extraction of data of the container CT by each communication device 6 in the modification of the first embodiment is described. Then, a transmission example in the modification of the first embodiment is described. Note that the transmission example according to the modification of the first embodiment illustrates a case where the container CT including data requesting a write operation is transmitted.

### 2.2.1. Operation of the Communication Device

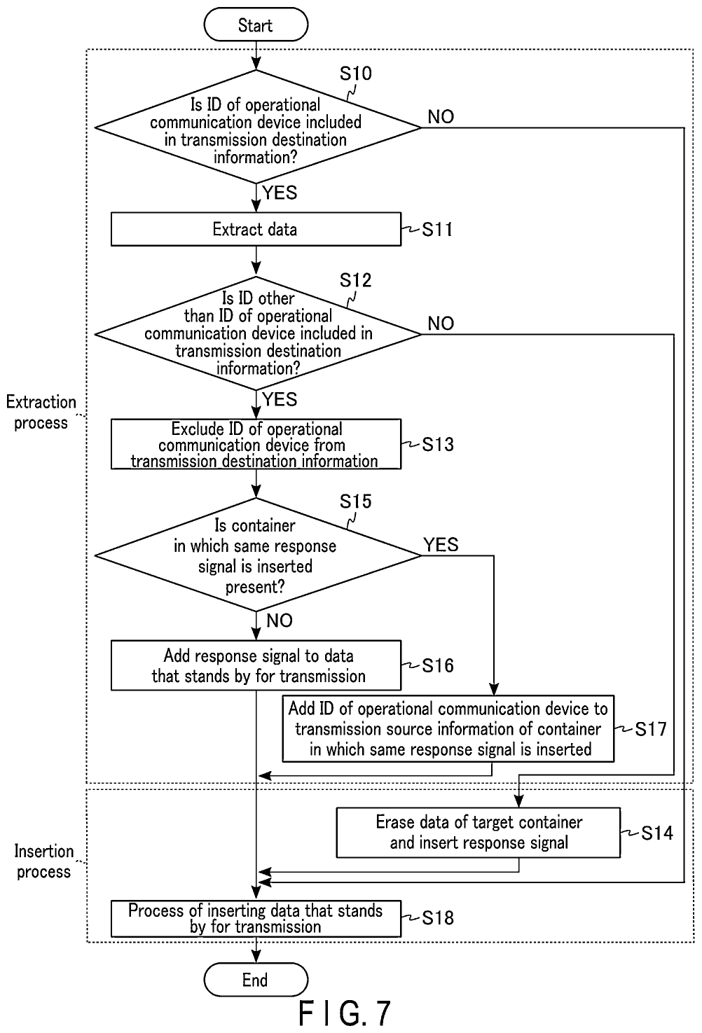

An example of the operation of the communication device 6 is described with reference to FIG. 7. FIG. 7 is a flowchart describing an example of the operation of the communication device in the communication system according to the modification of the first embodiment. Specifically, FIG. 7 illustrates an example of a process for the communication frame FR by the communication device 6 according to the modification of the first embodiment.

A process of S10 is similar to the process of S0 in the first embodiment. If the identification information ID of the communication device 6, which received the communication frame FR, is included as the transmission destination information of the container header CH of each container CT of the communication frame FR (S10; YES), the process proceeds to S11. If the identification information ID of the above-described communication device 6 is not included as the transmission destination information (S10; NO), the process proceeds to S18.

Processes of S11 to S14 are similar to the processes of S1 to S3, and S5 in the first embodiment. After the process of S13, the process proceeds to S15. In addition, after the process of S14, the process proceeds to S18.

The communication control circuitry 64 determines whether, among the containers CT included in the communication frame FR, there is a container CT in which the same response signal as the response signal of the communication device 6 (operational communication device 6) that executed data extraction is already inserted (S15).

If the container CT in which the same response signal as the response signal of the operational communication device 6 is already inserted is absent (S15; NO), a process similar to the process of S4 of the first embodiment is executed (S16). Then, the process proceeds to S18.

If the container CT in which the same response signal as the response signal of the operational communication device 6 is already inserted is present (S15; YES), the communication control circuitry 64 converts the transmission source information of the container CT to the transmission source information to which the identification information ID of the operational communication device 6 is added (S17). Specifically, the communication control circuitry 64 converts the transmission source information of the above-described container CT to the transmission source information in which the identification information ID of the operational communication device 6 is added to the transmission source information at the time of reception by the receiving unit 61. Thereby, it can be confirmed that the data of the container CT is the response signal from a plurality of communication devices 6 specified by the converted transmission source information. Then, the process proceeds to S18.

The communication control circuitry 64 executes a process of inserting data that stands by for transmission (S18). The process (S18) of inserting data that stands by for transmission is similar to the process of S6 to S8 in the first embodiment.

The communication frame FR, which is updated as described above, is transmitted from the transmitting unit 62 of the operational communication device 6. Then, the process is terminated.

In the above-described operation of the communication device 6, the processes of S10 to S13, and S15 to S17 can be called “extraction process”. In addition, the processes of S14 and S18 can be called “insertion process”.

Note that, instead of the above-described process of S15, it may be determined whether, among the containers CT included in the communication frame FR, there is a container CT in which the response signal is already inserted. Then, when the container CT in which the response signal is already inserted is absent, a process similar to S16 is executed. On the other hand, when the container CT in which the response signal from another transmission source is already inserted is present, the insertion of the response signal, and the conversion of the transmission source information, similarly to S17, are executed. In this case, a plurality of response signals are inserted in one container CT. As regards each of the response signals inserted in one container CT, the host controller 4 can determine which communication device 6, among the communication devices 6, is related to the response signal, for example, based on the order of the inserted response signals, the order of pieces of transmission source information, and the like.

### 2.2.2. Transmission Example of the Modification of the First Embodiment

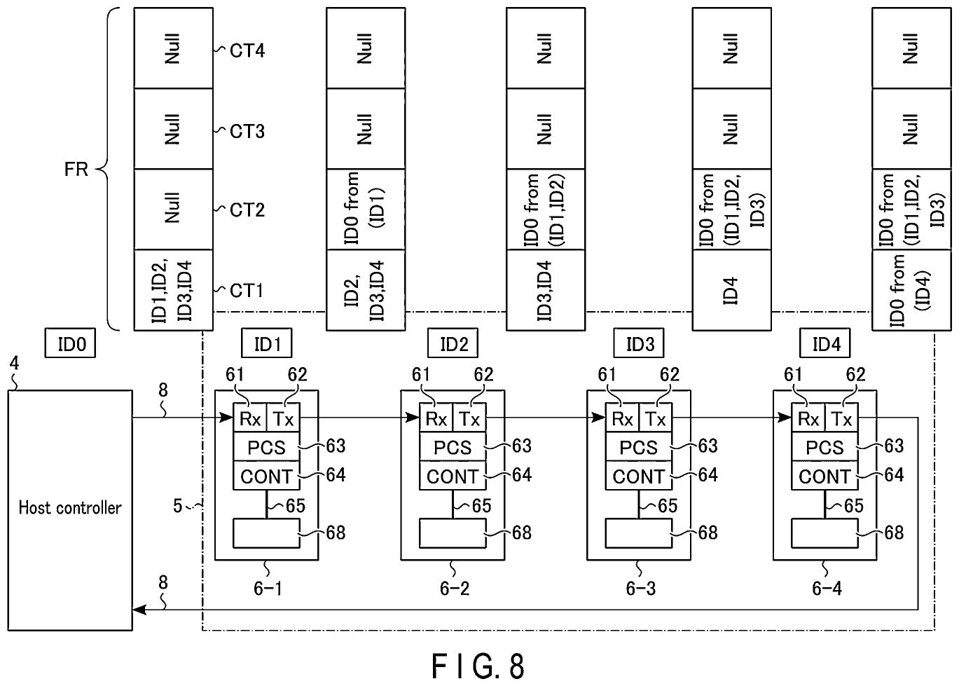

Referring to FIG. 8, a description is given of a transmission example of the communication frame FR in the ring connection according to the modification of the first embodiment. FIG. 8 is a diagram illustrating the transmission example of the communication frame in the ring connection of the communication system according to the modification of the first embodiment. FIG. 8 illustrates containers CT1 to CT4 included in the communication frame FR at a time when the processes by the communication devices 6 were successively executed. Note that in the transmission example below, a case is illustrated in which, by way of example, each communication device 6 that executed data extraction transmits an identical response signal to the host controller 4. In addition, in FIG. 8, transmission source information is indicated in parentheses ( ) in the container CT in which the response signal is inserted.

The host controller 4, for example, transmits to the communication device 6-1 a communication frame FR that is similar to the communication frame FR in the second transmission example of the first embodiment.

A process by the communication device 6-1 is substantially the same as the process by the communication device 6-1 in the second transmission example of the first embodiment. In the communication device 6-1, the communication control circuitry 64 converts the transmission source information of the container CT2, in which the response signal is inserted, to identification information ID1.

A process by the communication device 6-2 is similar to the process by the communication device 6-2 in the second transmission example of the first embodiment, except for the insertion of the response signal. In the communication device 6-2, the communication control circuitry 64 converts the transmission source information of the container CT2, in which the response signal is already inserted, from the identification information ID1 to identification information ID1 and ID2. Note that the insertion of the response signal by the communication device 6-2 is not executed.

A process by the communication device 6-3 is similar to the process by the communication device 6-3 in the second transmission example of the first embodiment, except for the insertion of the response signal. In the communication device 6-3, the communication control circuitry 64 converts the transmission source information of the container CT2, in which the response signal is inserted, from the identification information ID1 and ID2 to identification information ID1, ID2 and ID3. Note that the insertion of the response signal by the communication device 6-3 is not executed.

A process by the communication device 6-4 is similar to the process by the communication device 6-4 in the second transmission example of the first embodiment. The communication control circuitry 64 converts the transmission source information of the container CT1, in which the response signal is inserted, to identification information ID4. Note that the communication control circuitry 64 of the communication device 6-4 may transmit the response signal, not by the container CT1 but by the container CT2. In this case, the communication control circuitry 64 converts the transmission source information of the container CT2, in which the response signal is inserted, from the identification information ID1, ID2 and ID3 to identification information ID1, ID2, ID3 and ID4.

By the above, the process in the transmission example according to the modification of the first embodiment is terminated.

Also by the modification of the first embodiment, the same advantageous effects as in the first embodiment can be obtained.

Furthermore, according to the modification of the first embodiment, each container CT can include a plurality of pieces of identification information ID as the transmission source information. Thereby, for example, in the transmission of data such as the response signal from each communication device 6 to the host controller 4, a decrease in efficiency of use of the communication frame FR can be suppressed.

### 3. Second Embodiment

In the first embodiment, the example was illustrated in which identical data is written in a plurality of communication devices 6 by the inclusion of a plurality of transmission destinations in each container CT, but the embodiment is not limited to this. In a case of writing identical data in a plurality of communication devices 6, for example, use may be made of a copy commend that instructs that data stored in one communication device 6 is to be copied into another communication device 6 different from this communication device 6. Hereinafter, a description of the configuration of a second embodiment, which is similar to the configuration of the first embodiment, is omitted or simplified, and the configuration different from the first embodiment is mainly described.

The configurations of the system board 2, connector 3, host controller 4, communication devices 6, boards 7 and communication paths 8 according to the second embodiment are similar to those according to the first embodiment and the modification of the first embodiment. Hereinafter, a copy command and a transmission example in the communication system 1 according to the second embodiment are mainly described.

### 3.1. Copy Command

The copy command according to the second embodiment is described.

The copy command is, for example, a command for instructing that the same data as the data stored in a communication device 6 of a copy source is to be copied to a communication device 6 of a copy destination. The copy command is included in, for example, the packet header PH of the container payload CP. The identification information ID of the communication device 6 of the copy source and the identification information ID of the communication device 6 of the copy destination are included in, for example, the packet payload PP. In addition, the address of the data stored in the communication device 6 of the copy source is also included in, for example, the packet payload PP.

Note that the container CT including the copy command is transmitted to the communication device 6 of the copy source, with the transmission destination information being set to the identification information ID of the communication device 6 of the copy source.

### 3.2. Operation

Hereinafter, an operation example of the communication system 1 according to the second embodiment is described. At first, a description is given of an operation based on the copy command by each communication device 6 in the second embodiment. Then, a first transmission example and a second transmission example in the second embodiment are described.

### 3.2.1. Operation of the Communication Device Based on the Copy Command

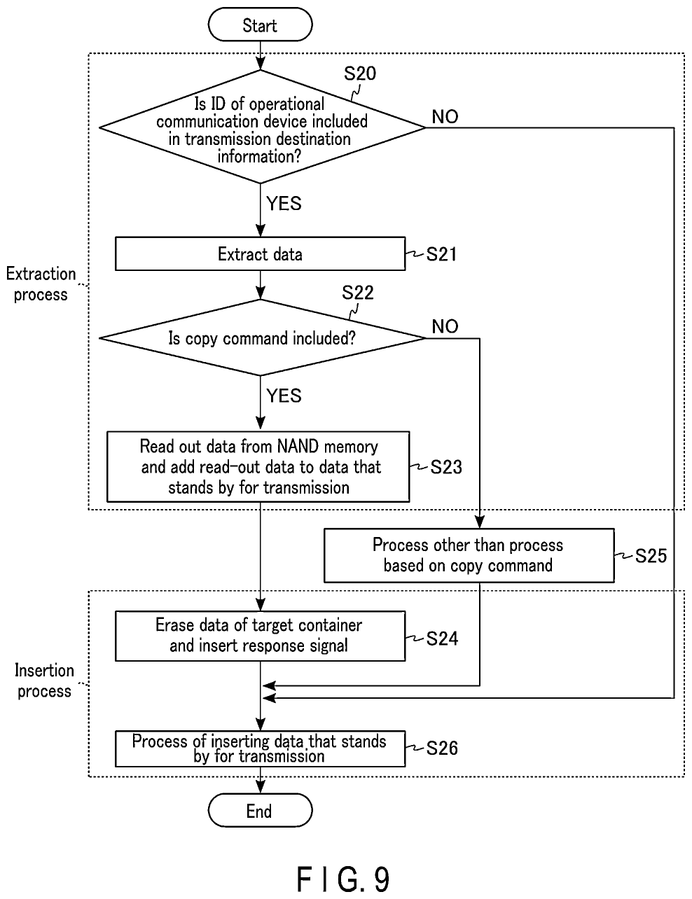

An example of the operation of the communication device 6 is described with reference to FIG. 9. FIG. 9 is a flowchart describing an example of the operation of the communication device in the communication system according to the second embodiment. Specifically, FIG. 9 illustrates an example of a process for the communication frame FR by the communication device 6 according to the second embodiment.

A process of S20 is similar to the process of S0 of the operation in the first embodiment and to the process of S10 of the operation in the modification of the first embodiment. If the identification information ID of the communication device 6, which received the communication frame FR, is included as the transmission destination information of the container header CH of each container CT of the communication frame FR (S20; YES), the process proceeds to S21. If the identification information ID of the above-described communication device 6 is not included as the transmission destination information (S20; NO), the process proceeds to S26.

A process of S21 is similar to the process of S1 of the operation in the first embodiment and to the process of S11 of the operation in the modification of the first embodiment. After the process of S21, the process proceeds to S22.

The communication control circuitry 64 determines whether the extracted data (for example, the packet header PH of the container payload CP) includes the copy command (S22). If the extracted data includes the copy command (S22; YES), the process proceeds to S23. If the extracted data does not include the copy command (S22; NO), the process proceeds to S25.

If the extracted data includes the copy command (S22; YES), the operational communication device 6 reads out data from the NAND memory 602, and adds the read-out data to the data that stands by for transmission (S23). To be more specific, based on the copy command and address, the CPU 66 controls the NAND controller 68, and causes the NAND controller 68 to execute a read operation for the NAND memory 602. Thereby, the data stored in the communication device 6 of the copy source is read out. The communication control circuitry 64 adds the read-out data to the data standing by for transmission in the operational communication device 6. Note that in a case where the data standing by for transmission is absent in the operational communication device 6 at a time when the data extraction was executed as described above, the communication control circuitry 64 sets the read-out data to be the data standing by for transmission. Then, the process proceeds to S24. Note that in the process of (S23), the process may proceed to (S24), for example, after a certain time has passed since the read-out of data was started, without waiting for the completion of the read-out of the data and the addition of the read-out data to the data standing by for transmission. In addition, in the process of (S23), when the read-out of the data and the addition of the read-out data to the data standing by for transmission are completed before the certain time has passed, the process may proceed to (S24) at this time point.

Like the process of S5 of the first embodiment and the process of S14 of the modification of the first embodiment, the communication control circuitry 64 erases the data of the target container CT and inserts the response signal (S24).

If the extracted data does not include the copy command (S22; NO), each communication device 6, for example, executes a process similar to the process included in the process for the extracted data in the first embodiment and in the modification of the first embodiment (S25). For example, the processes of S2 to S5 in the first embodiment, or the processes of S12 to S17 in the modification of the first embodiment, is executed. Then, the process proceeds to S26.

The communication control circuitry 64 executes the process of inserting the data standing by for transmission (S26). To be more specific, a process similar to S6 and S7 in the first embodiment is first executed. In addition, when it is determined that the extracted data includes the copy command (S22; YES), the communication control circuitry 64 converts, in a process corresponding to S8 of the first embodiment, the transmission destination information of the container CT in the empty state to the identification information ID of the communication device 6 of the copy destination. In addition, the communication control circuitry 64 inserts a write request of the data that was read out in S23, and the data standing by for transmission, which includes the read-out data, into the container CT in which the transmission destination information was converted as described above. On the other hand, when it is determined that the extracted data does not include the copy command (S22; NO), a process similar to S8 in the first embodiment is executed.

The communication frame FR that was updated as described above is transmitted from the transmitting unit 62. Then, the process is terminated.

In the above-described operation of the communication device 6, the processes of S20 to S23 are included in the extraction process. In addition, the processes of S24 and S26 are included in the insertion process. Note that in the process of S25, the processes included in the extraction process and the insertion process can be executed.

### 3.2.2. First Transmission Example

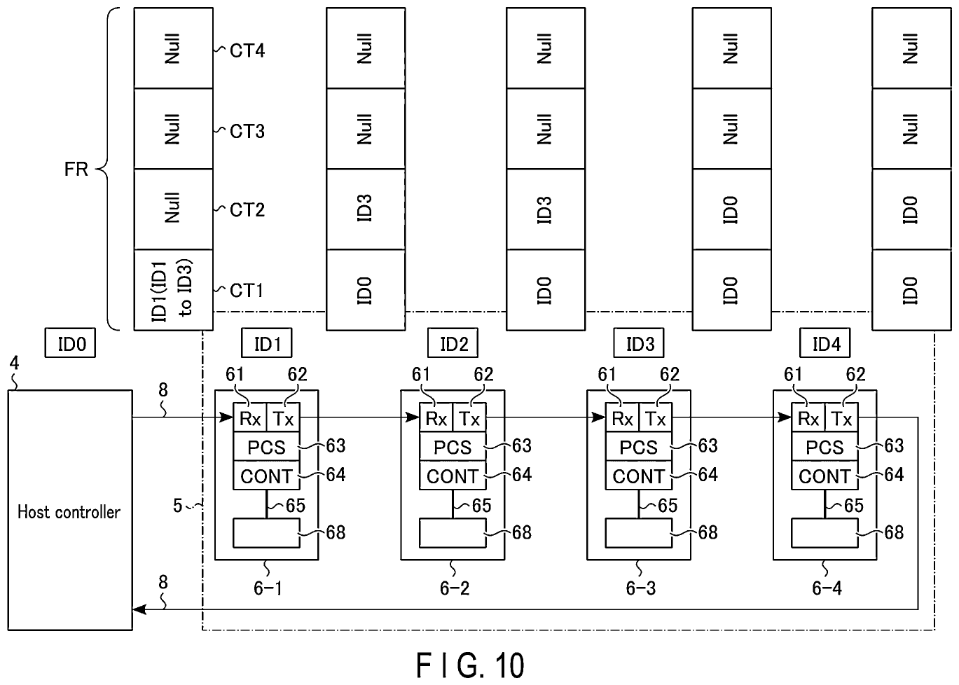

Referring to FIG. 10, a description is given of a first transmission example of the communication frame FR in the ring connection according to the second embodiment. FIG. 10 is a diagram illustrating the first transmission example of the communication frame in the ring connection of the communication system according to the second embodiment. FIG. 10 illustrates containers CT1 to CT4 included in the communication frame FR at a time when the processes by the communication devices 6 were successively executed.

The host controller 4, for example, transmits to the communication device 6-1 a communication frame FR in which data including the copy command for the identification information ID1 (communication device 6-1) is stored in the container CT1, and the containers CT2, CT3 and CT4 are in the empty state (Null). Note that in the container CT1 of FIG. 10, the target of the copy command is indicated in parentheses ( ) In addition, in FIG. 10, the copy command is illustrated as “the identification information ID of the communication device 6 of the copy source to the identification information ID of the communication device 6 of the copy destination”. In the example of FIG. 10, the copy command is a command that instructs that the data to be stored in the communication device 6-1 is to be copied to the communication device 6-3.

In the communication device 6-1, the extraction of data of the container CT1 is executed. In addition, based on the copy command, the read operation for the NAND memory 602 of the communication device 6-1 is executed. The communication control circuit 64 converts the transmission destination information of the container CT2 in the empty state to the identification information ID3 of the communication device 6-3 of the copy destination. In addition, the communication control circuitry 64 inserts the data read out based on the copy command, as write data, together with the write request, into the container CT2 in the empty state. Furthermore, the communication control circuitry 64 inserts the response signal into the container CT1, with the host controller 4 being set as the transmission destination. Then, the communication device 6-1 transmits the updated communication frame FR to the communication device 6-2.

In the communication device 6-2, the data extraction and the update of the communication frame FR are not executed. Then, the communication device 6-2 transmits the communication frame FR having the same content as the received transmission frame FR to the communication device 6-3.

In the communication device 6-3, the extraction of data of the container CT2 is executed. In addition, based on the extracted data, a write operation for the NAND memory 602 of the communication device 6-3 is executed. Thereby, based on the copy command, the data that was read out from the communication device 6-1 is copied to the communication device 6-3. In addition, the communication control circuitry 64 inserts the response signal into the container CT2, with the host controller 4 being set as the transmission destination. Then, the communication device 6-3 transmits the updated communication frame FR to the communication device 6-4.

In the communication device 6-4, the data extraction and the update of the communication frame FR are not executed. Then, the communication device 6-4 transmits the communication frame FR having the same content as the received transmission frame FR to the host controller 4.

By the above, the process in the first transmission example of the second embodiment is terminated.

### 3.2.3. Second Transmission Example

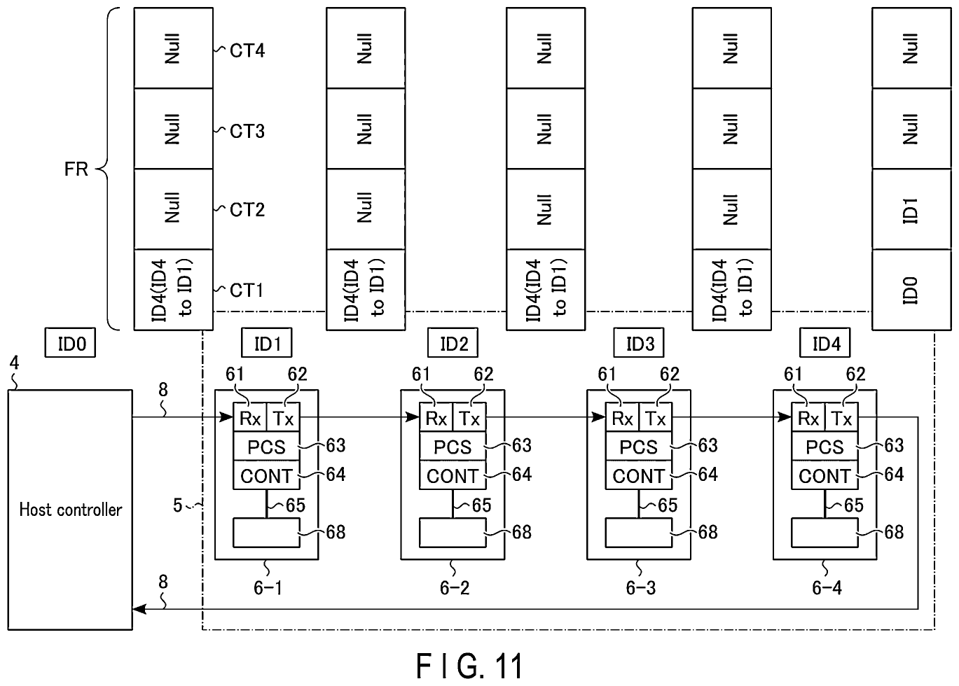

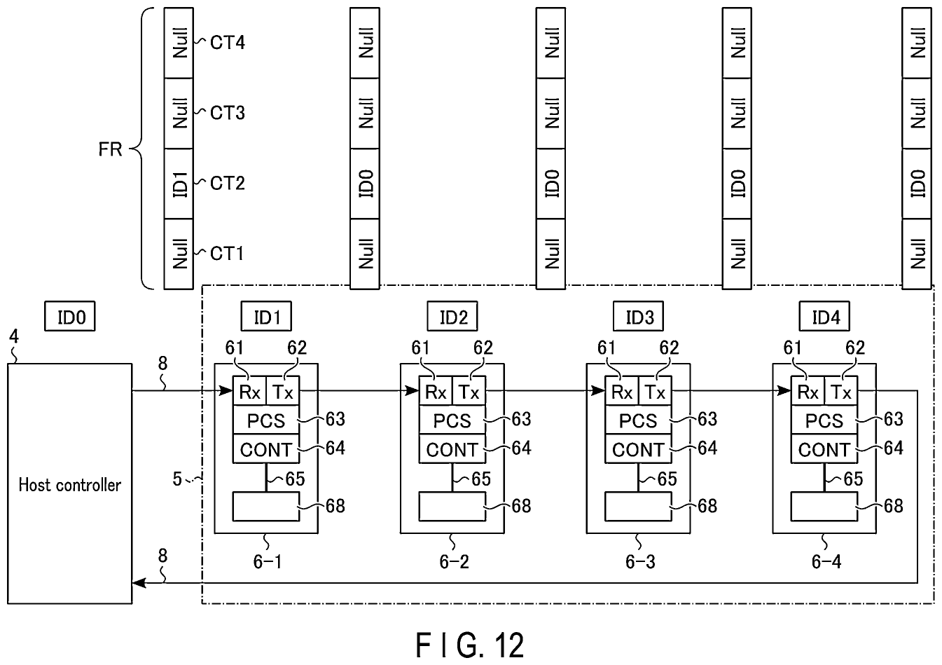

Referring to FIG. 11 and FIG. 12, a description is given of a second transmission example of the communication frame FR in the ring connection according to the second embodiment. FIG. 11 and FIG. 12 are diagrams illustrating the second transmission example of the communication frame in the ring connection of the communication system according to the second embodiment. FIG. 11 and FIG. 12 illustrate containers CT1 to CT4 included in the communication frame FR at a time when the processes by the communication devices 6 were successively executed.

As illustrated in FIG. 11, the host controller 4, for example, transmits to the communication device 6-1 a communication frame FR in which data including the copy command for the identification information ID4 (communication device 6-4) is stored in the container CT1, and the containers CT2, CT3 and CT4 are in the empty state (Null). Note that in the container CT of FIG. 11, the target of the copy command is indicated in parentheses ( ) similarly as in FIG. 10. In the example of FIG. 11, the copy command is a command that instructs that the data to be stored in the communication device 6-4 is to be copied to the communication device 6-1.

In the communication devices 6-1 to 6-3, the data extraction and the update of the communication frame FR are not executed. Thereby, the communication devices 6-1 to 6-3 transmit the communication frame FR having the same content as the received transmission frame FR to the communication devices 6-2 to 6-4, respectively.

In the communication device 6-4, the extraction of data of the container CT1 is executed. In addition, based on the copy command, the read operation for the NAND memory 602 of the communication device 6-4 is executed. The communication control circuit 64 converts the transmission destination information of the container CT2 in the empty state to the identification information ID1 of the communication device 6-1 of the copy destination. In addition, the communication control circuitry 64 inserts the data read out based on the copy command, as write data, together with the write request, into the container CT2 in the empty state. Furthermore, the communication control circuitry 64 inserts the response signal into the container CT1, with the host controller 4 being set as the transmission destination. Then, the communication device 6-4 transmits the updated communication frame FR to the host controller 4.

The host controller 4, for example, executes a process for a container CT including the data corresponding to the host controller 4 in the communication frame FR that the host controller 4 received. In addition, in a case where the communication frame FR that the host controller 4 received includes a container CT in which data, whose transmission destination is the communication device 6, is stored, the host controller 4, for example, transmits to the communication device 6-1 the communication frame FR including the container CT in which the data corresponding to this communication device 6 is stored. In the example illustrated in FIG. 12, the host controller 4 transmits to the communication device 6-1 the data included in the container CT2 that was transmitted from the communication device 6-4 in FIG. 11. To be more specific, the host controller 4, for example, transmits to the communication device 6-1 a communication frame FR in which the containers CT1, CT3 and CT4 are in the empty state (Null), and data corresponding to the identification information ID1 (communication device 6-1) is stored in the container CT2.

In the communication device 6-1, the extraction of data of the container CT2 and the write operation based on the data of the container CT2 are executed. Thereby, based on the copy command, the data that is read out from the communication device 6-4 is copied to the communication device 6-1. In addition, the communication control circuitry 64 inserts the response signal into the container CT2, with the host controller 4 being set as the transmission destination. Then, the communication device 6-1 transmits the updated communication frame FR to the communication device 6-2.

After the copy of data was executed as described above, the data extraction and the update of the communication frame FR by the communication devices 6-2 to 6-4 are not executed in the process described with reference to FIG. 12. Thereby, the communication device 6-4 transmits the communication frame FR having the same content as the received communication frame FR to the host controller 4.

By the above, the process in the second transmission example of the second embodiment is terminated.

Also by the second embodiment, the same advantageous effects as in the first embodiment can be obtained. In other words, also by the second embodiment, the transmission of a plurality of containers each including substantially identical data can be suppressed, and a decrease in efficiency of use of the communication frame can be suppressed.

### 4. Third Embodiment

In the first embodiment and second embodiment, the example was illustrated in which the processing capability of communication is improved by suppressing the decrease in efficiency of use of the communication frame at a time of writing identical data in a plurality of communication devices, but the embodiments are not limited this. In a third embodiment, based on a disconnection command to a certain communication device among a plurality of communication devices, this certain communication device is rendered unusable and, in this state, transfer of data to other communication devices is enabled, thereby suppressing a decrease in processing capability due to interruption of communication. Hereinafter, a description of the configuration of the third embodiment, which is similar to the configurations of the first embodiment, the modification of the first embodiment and the second embodiment, is omitted, and the configuration different from the first embodiment, the modification of the first embodiment and the second embodiment is mainly described.

The configurations of the system board 2, connector 3, host controller 4, boards 7 and communication paths 8 according to the third embodiment are similar to those according to the first embodiment, the modification of the first embodiment, and the second embodiment.

Note that in each communication device 6 according to the third embodiment, the NAND memories 602 are driven by an exclusive power supply that is different from, for example, the power supply for driving the other structural components in the communication device 6. In addition, each NAND memory 602 is mounted by using, for example, a connection member, such as a connector or a socket, by which the NAND memory 602 is configured to be detachable. The configurations of the receiving unit 61, transmitting unit 62, protocol conversion unit 63, internal bus 65, CPU 66, DRAM controller 67, NAND controller 68, SRAM 69, DRAM 601 and NAND memory 602 in the communication device 6 according to the third embodiment are similar to those configurations according to the first embodiment, the modification of the first embodiment and the second embodiment, except for the above-described power supply and method of mounting.

Hereinafter, the disconnection command and a transmission example in the communication system according to the third embodiment are mainly described.

### 4.1. Disconnection Command

The disconnection command according to the third embodiment is described.

The disconnection command is a command that instructs that the connection between the communication control circuitry 64 and the NAND memory 602 in the communication device 6 is to be logically disconnected. The disconnection command is included in, for example, the packet header PH of the container payload CP. Note that in the description below, to disconnect the connection between the communication control circuitry 64 and the NAND memory 602 by the disconnection command is referred to as “to inactivate”. In the inactivated communication device 6, although the connection between the communication control circuitry 64 and the NAND memory 602 is disconnected, the inactivated communication device 6 is configured to be capable of executing the transmission of the communication frame FR via the receiving unit 61 and transmitting unit 62.

The transmission destination information of the container CT including the disconnection command is set to be the identification information ID of the communication device 6 that is inactivated. Thereby, the communication device 6, which is set to be the transmission destination of the container CT including the disconnection command, is inactivated by, for example, the communication control circuitry 64.

### 4.2. Operation

Hereinafter, an operation example of the communication system 1 according to the third embodiment is described. At first, a description is given of an operation based on the disconnection command by each communication device 6 in the third embodiment. Then, a transmission example in the third embodiment is described.

### 4.2.1. Operation of the Communication Device Based on the Disconnection Command

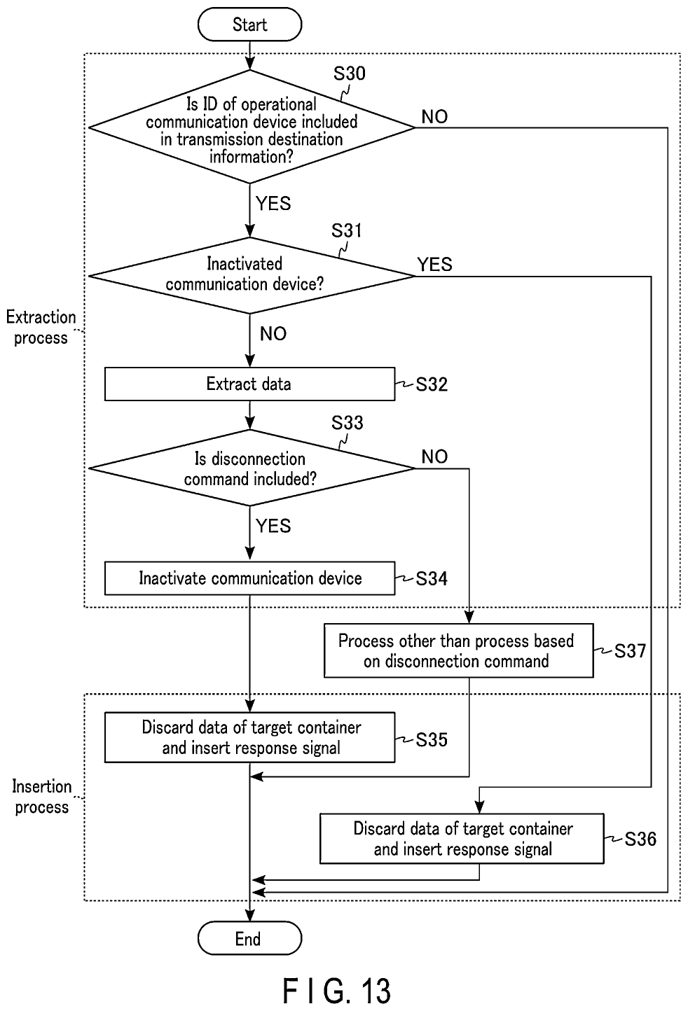

An example of the operation of the communication device 6 is described with reference to FIG. 13. FIG. 13 is a flowchart describing an example of the operation of the communication device in the communication system according to the third embodiment. Specifically, FIG. 13 illustrates an example of a process for the communication frame FR by the communication device 6 according to the third embodiment.

A process of S30 is similar to the process of S0 of the operation in the first embodiment, the process of S10 of the operation in the modification of the first embodiment, and the process of S20 of the operation in the second embodiment. If the identification information ID of the communication device 6, which received the communication frame FR, is included as the transmission destination information of the container header CH of each container CT of the communication frame FR (S30; YES), the process proceeds to S31. If the identification information ID of the above-described communication device 6 is not included (S30; NO), the process for the communication frame FR is terminated.

In each communication device 6, for example, the communication control circuitry 64 determines whether the own communication device 6 is an inactivated communication device 6 (S31). If the own communication device 6 is the inactivated communication device 6 (S31; YES), the process proceeds to S36. If the own communication device 6 is not the inactivated communication device 6 (S31; NO), the process proceeds to S32.

A process of S32 is similar to the process of S1 of the operation in the first embodiment, the process of S11 of the operation in the modification of the first embodiment, and the process of S21 of the operation in the second embodiment. Then, the process proceeds to S33.

The communication control circuitry 64 determines whether the data extracted in the process of S32 (for example, the packet header PH of the container payload CP) includes the disconnection command (S33). If the data does not include the disconnection command (S33; NO), the process proceeds to S37.

If the data includes the disconnection command (S33; YES), the CPU 66, for example, disconnects the connection between the communication control circuitry 64, and the NAND controller 68 and NAND memory 602, via the internal bus 65, based on the disconnection command included in the extracted data (S34). Thereby, the communication device 6 is inactivated. Then, the process proceeds to S35.

In the inactivated communication device 6, the communication control circuitry 64 inserts a response signal INACT, which indicates that the communication device 6 is in the inactivated state, with the host controller 4 being set as the transmission destination (S35). To be more specific, the communication control circuitry 64 in the inactivated communication device 6, for example, discards the data of the target container CT, and inserts the response signal INACT into the container payload CP of the target container CT. In addition, the communication control circuitry 64, for example, converts the transmission destination information of the target container CT to the identification information ID0 of the host controller 4. Then, the process for the communication frame FR is terminated.

Note that, for example, in accordance with an instruction of the host controller 4, the communication device 6 that is inactivated by the disconnection command completes the transmission of the data standing by for transmission, which is stored in this communication device 6, before receiving the container CT including the disconnection command. Thereby, in the operation of the communication device 6 according to the third embodiment, the process of inserting the data standing by for transmission, by the inactivated communication device 6, is not executed.

If the own communication device 6 is the inactivated communication device 6 (S31; YES), the communication control circuitry 64, for example, does not execute the extraction of data from the container payload CP of the container CT, and inserts the response signal INACT into the container CT including the identification information ID of this communication device 6 (S36). To be more specific, the communication control circuitry 64, for example, discards the data of the container CT, and inserts the response signal INACT into the container payload CP of the container CT. In addition, the communication control circuitry 64, for example, converts the transmission destination information of the container CT to the identification information ID0 of the host controller 4. Specifically, the process of (S36) is substantially the same as the process of (S35). Then, the process for the communication frame FR is terminated.

If the data extracted in the process of S32 does not include the disconnection command (S33; NO), each communication device 6, for example, executes a process similar to the process for the extracted data in the first embodiment, the modification of the first embodiment and the second embodiment (S37). In other words, for example, the processes of S2 to S8 in the first embodiment, the processes of S12 to S18 in the modification of the first embodiment, or the processes of S22 to S26 of the second embodiment is executed. Then, the process for the communication frame FR is terminated.

The communication frame FR updated as described above is transmitted from the transmitting unit 62. Then, the process is terminated.

In the above-described operation of the communication device 6, the processes of S30 to S34 are included in the extraction process. In addition, the processes of S35 and S36 are included in the insertion process. Note that in the process of S37, the processes included in the extraction process and the insertion process can be executed.

### 4.2.2. Transmission Example of the Communication Frame

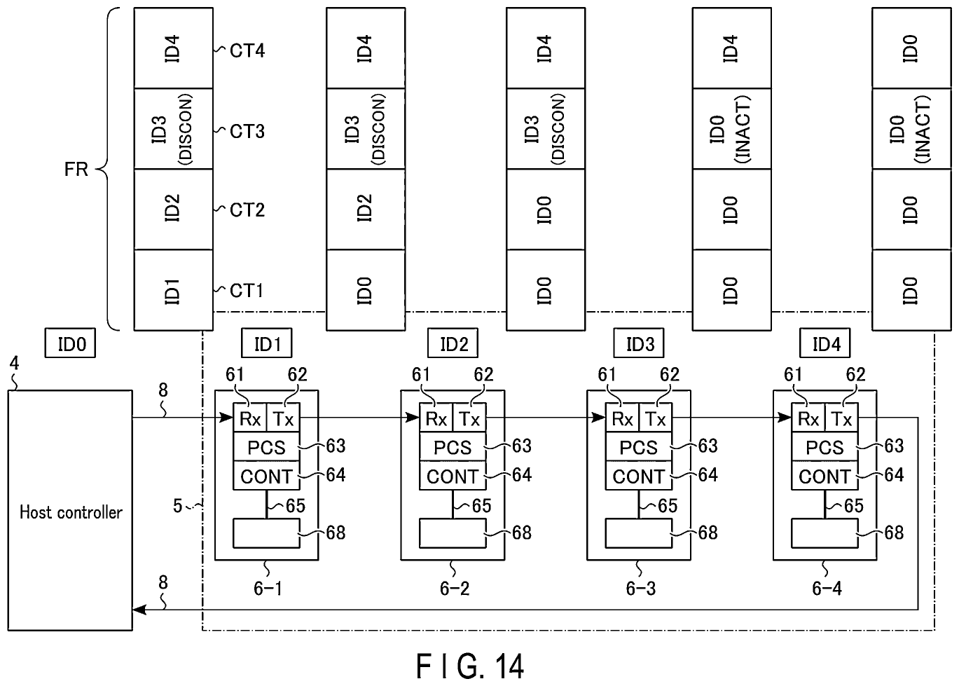

Next, referring to FIG. 14, a description is given of a transmission example of the communication frame FR in the ring connection according to the third embodiment. FIG. 14 is a diagram illustrating the transmission example of the communication frame in the ring connection of the communication system according to the third embodiment. FIG. 14 illustrates containers CT1 to CT4 included in the communication frame FR at a time when the processes by the communication devices 6 were successively executed.

The host controller 4, for example, transmits to the communication device 6-1 a communication frame FR in which data corresponding to the identification information ID1 (communication device 6-1) is stored in the container CT1, data corresponding to the identification information ID2 (communication device 6-2) is stored in the container CT2, a disconnection command and data corresponding to the identification information ID3 (communication device 6-3) are stored in the container CT3, and data corresponding to the identification information ID4 (communication device 6-4) is stored in the container CT4. Note that in FIG. 14, the disconnection command is indicated as “DISCON” in parentheses ( ) In addition, in FIG. 14, the response signal INACT is indicated as “INACT” in parentheses ( ). Besides, in the example of FIG. 14, at a time when the host controller 4 transmits the communication frame FR, none of the communication devices 6 is inactivated.

In the communication device 6-1, the extraction of data of the container CT1 and the operation based on the extracted data are executed. In addition, the communication control circuitry 64, for example, inserts the response signal to the host controller 4 into the container CT1. In this manner, the communication frame FR is updated. Then, the communication device 6-1 transmits the updated communication frame FR to the communication device 6-2.

An operation in the communication device 6-2 is similar to the operation of the communication device 6-1 in the transmission example of the third embodiment, except that a process for the container CT2 is executed. Thereby, the communication frame FR is updated. Then, the communication device 6-2 transmits the updated communication frame FR to the communication device 6-3.

At a time when the communication device 6-3 received the communication frame FR transmitted from the communication device 6-2, the communication device 6-3 is not inactivated. Thereby, in the communication device 6-3, the extraction of data of the container CT3 is executed. In addition, based on the disconnection command included in the container CT3, the CPU 66 logically disconnects the connection between the communication control circuitry 64 and the NAND controller 68. Thereby, the communication device 6-3 is inactivated. Furthermore, the communication control circuitry 64 inserts the response signal INACT into the container CT3, with the host controller 4 being set as the transmission destination.

An operation in the communication device 6-4 is similar to the operations of the communication devices 6-1 and 6-2 in the transmission example of the third embodiment, except that a process for the container CT4 is executed. Thereby, the communication frame FR is updated. Then, the communication device 6-4 transmits the updated communication frame FR to the host controller 4.

By the above, the process in the transmission example of the third embodiment is terminated.

The communication device 6-3 that was inactivated by the above-described operation, for example, does not execute data extraction at a time when the container CT including data corresponding to the communication device 6-3 is transmitted thereafter, discards this data, and inserts the response signal INACT to the host controller 4.

By the above-described configuration, some communication devices 6 among the communication devices 6 that are ring-connected can be inactivated, without interrupting the transmission of the transmission frame FR in the ring connection. In addition, in the inactivated communication device 6, although the connection between the NAND controller 68 and the NAND memory 602 is disconnected, the inactivated communication device 6 is configured to be capable of executing the transfer of the communication frame FR via the receiving unit 61 and transmitting unit 62. Thereby, for example, the NAND memory 602 of the disconnected communication device 6 can be replaced without interrupting the transmission of the communication frame FR, by stopping the supply of power to the NAND memory 602 in the disconnected communication device 6 and by maintaining the supply of power to the other structural components. Therefore, also by the third embodiment, like the first embodiment and second embodiment, the processing capability of communication can be improved.

### 5. Others

In the above-described first embodiment, modification of the first embodiment, second embodiment and third embodiment, the cases were described in which the communication device 6 is the memory device including the NAND flash memory. However, the communication device 6 is not limited to the memory device. In addition, a plurality of communication devices 6 mounted on one device card 5 may be mutually different communication devices 6.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication device connected in a ring shape via a communication path, together with a host controller and a plurality of devices, the communication device comprising:
a receiving circuitry configured to receive from the communication path a communication frame of a serial signal including a plurality of containers including a first container;
a first circuitry configured to be capable of executing insertion and extraction of data for at least one of the plurality of containers; and
a transmitting circuitry configured to transmit to the communication path the communication frame based on a processing result of the first circuitry, wherein
each of the plurality of containers is capable of transferring data, with at least one of the host controller, the plurality of devices and the communication device being set as a transmission destination, and
after the receiving circuitry receives a first communication frame including the first container including, as transmission destinations, the communication device and a first device of the plurality of devices,
the transmitting circuitry is configured to transmit a second communication frame including the first container including the first device as a new transmission destination, with the communication device being excluded from the transmission destinations of the first container.

2. The communication device of claim 1, further comprising:
a memory device connected to the first circuitry via a bus and configured to store data; and
a processor connected to the memory device via the bus, wherein
after the receiving circuitry receives the first container including data relating to a write operation of first data to the communication device and the first device,
the processor is configured to control to write the first data to the memory device, and
the transmitting circuitry is configured to transmit the first container including data corresponding to the write operation of the first data to the first device.

3. The communication device of claim 1, wherein
after the receiving circuitry receives the plurality of containers including the first container, a transmission source of which is the host controller,
the transmitting circuitry is configured to transmit a second container of the plurality of containers, the second container being different from the first container and including response data to the host controller.

4. The communication device of claim 1, wherein each of the plurality of containers is capable of transmitting data, with two or more of the devices and the communication device being set as transmission sources.

5. The communication device of claim 4, wherein
in a case where the first communication frame includes a second container including first response data to the host controller, the second container being different from the first container and including as a transmission source a second device that is different from the first device among the plurality of devices,
after the receiving circuitry receives the first communication frame,
the transmitting circuitry is configured to transmit the second container including the first device and the second device as new transmission sources and including the first response, in a case where response data to the host controller by the first device is the first response data.

6. A communication system comprising:
the communication device of claim 1;
the host controller;
the plurality of devices; and
the communication path connecting the communication device, the host controller and the plurality of devices in the ring shape.

7. The system of claim 6, further comprising:
a memory device connected to the first circuitry via a bus and configured to store data; and
a processor connected to the memory device via the bus, wherein
after the receiving circuitry receives the first container including data relating to a write operation of first data to the communication device and the first device,
the processor is configured to control to write the first data to the memory device, and
the transmitting circuitry is configured to transmit the first container including data corresponding to the write operation of the first data to the first device.

8. The system of claim 6, wherein
after the receiving circuitry receives the plurality of containers including the first container, a transmission source of which is the host controller,
the transmitting circuitry is configured to transmit a second container of the plurality of containers, the second container being different from the first container and including response data to the host controller.

9. The system of claim 6, wherein each of the plurality of containers is capable of transmitting data, with two or more of the devices and the communication device being set as transmission sources.

10. A communication device connected in a ring shape via a communication path, together with a host controller and a plurality of devices, the communication device comprising:
a receiving circuitry configured to receive from the communication path a communication frame of a serial signal including a plurality of containers including a first container;
a first circuitry configured to be capable of executing insertion and extraction of data for at least one of the plurality of containers;
a memory device connected to the first circuitry and configured to store data; and
a transmitting circuitry configured to transmit to the communication path the communication frame based on a processing result of the first circuitry, wherein
each of the plurality of containers is capable of transferring a copy command, a transmission destination that is a copy source of the copy command, and a copy destination of the copy command, and
after the receiving circuitry receives a first communication frame including the first container that includes the communication device as a transmission destination and includes the copy command,
the first circuitry is configured to read out first data stored in the memory device, and
the transmitting circuitry is configured to transmit a second communication frame including as the transmission destination a first device that is the copy destination among the plurality of devices, and including second data requesting that the read-out first data be written to the first device.

11. The communication device of claim 10, wherein
after the receiving circuitry receives the first communication frame,
the transmitting circuitry is configured to transmit, in the second communication frame, the first container including a response signal to the copy command, and a second container that is different from the first container among the plurality of containers and including the second data.

12. A communication system comprising:
the communication device of claim 10;
the host controller;
the plurality of devices; and
the communication path connecting the communication device, the host controller and the plurality of devices in the ring shape.

13. The system of claim 12, wherein the host controller is configured to:
be capable of transmitting and receiving data to and from the communication device and the plurality of devices via the communication path; and
after receiving the plurality of containers including a third container that includes a third device among the plurality of devices as a transmission destination,
transmit the third container including the third device as a new transmission destination.

14. The system of claim 12, wherein
after the receiving circuitry receives the first communication frame,
the transmitting circuitry is configured to transmit, in the second communication frame, the first container including a response signal to the copy command, and a second container that is different from the first container among the plurality of containers and including the second data.

15. A communication device connected in a ring shape via a communication path, together with a host controller and a plurality of devices, the communication device comprising:
a receiving circuitry configured to receive from the communication path a communication frame of a serial signal including a plurality of containers including a first container;
a first circuitry configured to be capable of executing insertion and extraction of data for at least one of the plurality of containers; and
a memory device connected to the first circuitry and configured to store data, wherein
each of the plurality of containers is capable of transferring a disconnection command to disconnect a connection to the memory device, and
after the receiving circuitry receives a first communication frame including the first container that includes the communication device as a transmission destination and includes the disconnection command,
the first circuitry is configured to logically disconnect a connection between the first circuitry and the memory device, based on the disconnection command.

16. The communication device of claim 15, wherein the memory device is configured to be detachable via a connection member.

17. The communication device of claim 16, wherein a power supply for driving the receiving circuitry and the first circuitry is different from a power supply for driving the memory device.

18. The communication device of claim 15, wherein
the communication device further includes a transmitting circuitry configured to transmit to the communication path the communication frame based on a processing result of the first circuitry, and
after the receiving circuitry receives the first communication frame,
the transmitting circuitry is configured to transmit a second communication frame including the first container that includes the host controller as a new transmission destination and includes a response signal to the disconnection command.

19. A communication system comprising:
the communication device of claim 15;
the host controller;
the plurality of devices; and
the communication path connecting the communication device, the host controller and the plurality of devices in the ring shape.

20. The system of claim 19, wherein the memory device is configured to be detachable via a connection member.
